(19) United States
(12) Patent Application Publication
(10) Pub. No.: US 2007/0285017 A1
(43) Pub. Date: Dec. 13, 2007

(54) HIGH-INTENSITY DISCHARGE LAMP WITHOUT OR WITH LOW MERCURY

(76) Inventors: Zhengming Yang, Foshan City (CN); Guosheng Chai, Foshan City (CN); Ming Zhang, Foshan City (CN); Guangyi Gao, Foshan City (CN)

Correspondence Address: Michael L. Crapenhoft;c/o Hiroe and Associates, 4-3 Usa 3-chome, Gifu City, 500-8368, JP

(21) Appl. No.: 11/781,929

(22) Filed: Jul. 23, 2007

(30) Foreign Application Priority Data
Jan. 28, 2005 (CN) 200510032932.5
May 12, 2005 (CN) 200510034602.X

(51) Int. Cl. H01J 61/12; H01J 17/20

(52) U.S. Cl. 313/637

(57) ABSTRACT

The present invention disclosed a high-intensity discharge lamp without or with low mercury, including the metallic halide discharge lamp, the high pressure mercury lamp and the mercury-xenon lamp and so on. When the high-intensity discharge lamp without or with low mercury according to the invention is used, the optimum amount of Se or HgSe is determined based on the type and the power of the lamps to substitute for the mercury partially or completely. Thus a proper light spectrum can be reached with a high color rendering index (for example 95). The mercury packed in the high-intensity discharge lamp without or with low mercury according to the invention can be substituted completely or reduced greatly. The lamp meets the requirement of the environmental protection and is a potential new-style light source.

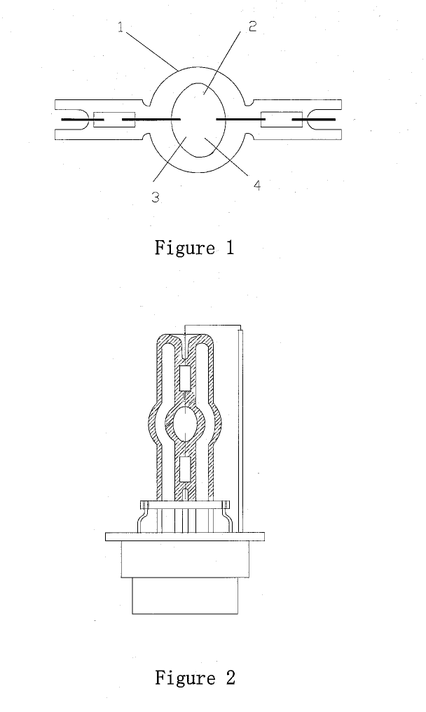

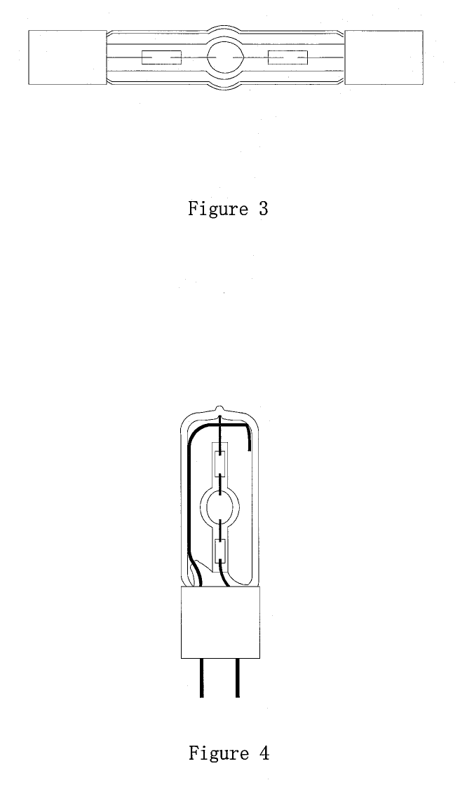

### FIELD OF THE INVENTION

The invention relates a high-intensity discharge lamp without or with low mercury, in particular a discharge lamp packed with metallic halide without or with low mercury. Background of the invention

At present, liquid mercury is widely used as the luminary materials or packing gas in various discharge lamps. Many kinds of mercurial alloys are applied in some low pressure discharge lamps such as fluorescent lamp and ultraviolet lamp. At a proper temperature, the mercurial alloy will release the mercury contained as an ionized gas in the form of vapor, and the other metal which is only a carrier of the mercurial alloy will not react in any process.

Liquid mercury is still widely used in the high-intensity discharge lamps such as metallic halide lamp, high pressure mercury lamp, high pressure sodium discharge lamp, super-high pressure mercury lamp, mercury-xenon lamp and so on. The mercury is a poisonous material which pollutes atmosphere, headwaters and soil, and it is very difficult to be removed after it gets into human body and domestic animals, and it will be greatly detrimental to the organism resulted in weakened body, aged earlier than expected, dementia, deformity of fetus, mentally deficient, reduced life and so on. Therefore the trend of mercury prohibition is getting stronger. According to the trend, it can be expected that production and distribution of all kinds of the products containing mercury will be prohibited in several years including certainly various light source containing mercury.

About ten years ago, the research of the high-intensity discharge lamps without mercury such as the metallic halide lamps has been started, but so far it is not successful. A proposal of use of the xenon to substitute for the mercury has been put forward, but the pressure-drop of the lamps is super low and the electric current is very large, in addition the lighting efficiency is very low. The consumption of electric power will get higher in order to reach the same lighting effect, so it is not suitable for general illumination. Another proposal of using zinc to substitute for mercury has been put forward, but the melting point of zinc is 420° C. and the boiling point is as high as 907° C. Therefore the working temperature of the tube of electric arc should be as high as above 1400K in order to evaporate a large quantity of zinc to form a high enough vapor pressure of zinc. The quarts tube working at such a high temperature will be bombarded by a great number of metal, alkali metal and halide ion, thus not only it is subjected to corrosion but also the crystal of it is quite easy to be separated out, resulted in losing transparence, bubbling, bursting and reducing life of the lamps. Thus it is not practical. Other solutions of using some kinds of metallic halides such as ScI₃, ZnI₂ to substitute the mercury have been put forward, but it is not practical too, due to the reduced discharge voltage and other problems. Therefore a practical metallic halide discharge lamp without mercury is not available in the market at present. On the other hand, the development and popularization of the metallic halide discharge lamp without mercury are needed in terms of environment protection which is imperative. The technology of replacing and reducing the mercury in the high-intensity mercury discharge lamps has the same problem.

Content of the Invention

The object of the invention is to eliminate or reduce the detriment of the mercurial pollution so as to provide a high-intensity discharge lamp without or with low mercury. In particular, the invention relates to the metallic halide discharge lamps and many other kinds of the HID lamps that needs to be packed with the mercury in the prior art to insure the lamps having a high enough gas working pressure.

The objects of the invention mentioned above will be achieved through the following technology scheme:

Among the 92 elements in the nature, except for the mercury, only Se element or HgSe which is a stable compound thereof can be vaporized generously to form a high pressure steam under the working conditions in some kinds of HID lamps, especially in the metallic halide lamps or other HID lamp which needs to be packed with the liquid mercury in the prior art. Therefore it can be used to substitute for the mercury. The parameter of Se is as follows:

Se is an element of number 34 in the element periodic table. It has an atomic weight of 78.96 and has 6 isotopes. Se has a stable chemical property and its valence bond is 6, 4 and −2 and presents as 8 atomic covalence at ordinary times. It has an ionization potential of 9.75V that is slightly lower than that of mercury. It has resonance potentials of 5.95V and 6.30V respectively and the corresponding resonance radiations of it are 207.4 nm and 196 nm respectively. It has a melting point of 220° C., i.e 493K. It has a boiling point of 688° C., i.e 961K. Although its boiling point is higher than that of the mercury, the working temperature of the arc tube of the HID lamps such as metallic halide lamp, especially the xenon gas metallic halide lamp used for cars and the metallic halide lamp used for stage is satisfied completely. The property of HgSe is stable, it can be vaporized at the temperature of 500-600° to form a high enough vapor pressure. It can be dissociated to atomic Hg and Se which will discharge together at a high temperature of above 3000K near the electric arc. They will be combined to form a molecule HgSe as soon as the discharge stopped and the temperature decreased. There will not be a leakage of liquid mercury or mercury vapor even if the lamp was broken. In addition Se does not react with electrode, quartz or metallic halide, but it may replace partially the metal in the metallic halide to form a selenium-halide such as Se₂I₂, Se₂Br₂ and so on. The vaporization temperature of the selenium-halide is high, and it is solid at normal temperature. Further, it is similar to HgI₂ ,HgBr₂ at the working condition of the lamp, that is it will be vaporized to get into the recycle of halogen to form a dynamic balance. Therefore according the invention, a proper amount of Se and/or HgSe are packed into the lamp instead of the mercury. The total mole of Se packed is equivalent to that of the mercury replaced, and the exact amount of Se needed depends on the type, volume and power of the lamps. Of course, the mole of HgSe packed can be substituted by half of the mole of Se and half of the mole of mercury, and at the same time an inert gas at a proper pressure should be packed into the lamp such as xenon, krypton, argon and so on and a mixture of the metallic halide with a corresponding components should be packed also based on the color temperature designed. The components and amount of the inert gas and metallic halide are designed based on the prior art. The inert gas discharges at first in operation, and the arc tube is heated by the arc with large electric current and low voltage. A great number of Se and/or HgSe is vaporized when the temperature of the tube shell reaches 700° C., leading to a rapid increase of the vapor pressure. Following by an increase of the pressure-drop of the discharge, the discharge of the arc light occurred in the Se high pressure vapor and/or HgSe vapor and the vapor of the metallic halide packed. When the HID lamp according to the invention is used, the selected proper amount of Se/or HgSe depending on the type and the power of the lamps can substitute for mercury partly or completely. If a determination of other components such as metallic halide is conducted based on the prior art, a proper photoelectric characteristic and a proper light spectrum can be reached with a high color rendering index (for example 95). In various compact metallic halide lamps such as the xenon gas metallic halide lamp for car and the halide metallic halide lamp for stage, the bubble shell volume is small, and the wall has a high load and a high temperature, so it is easier to satisfy the requirement of Se for the temperature of the arc tube wall. Therefore Hg can be substituted by Se in the lamps completely. As for the traditional metallic halide lamps and other kinds of mercury lamps such as high pressure mercury lamps, mercury-xenon lamps with a low load of tube wall, a proper amount of Se and/or HgSe can be used to substitute partially for the mercury to reduce the amount of liquid mercury in the lamps. Those lamps with a satisfied characteristic that can be made using single Se to substitute for the mercury can be made by use of HgSe to substitute for the liquid mercury.

A certain amount of Se-halide compound can be added into the lamps if necessary, such as Se₂I₂, Se₂Br₂ etc. The amount of Se-halide added is different based on the type and power of the lamps. Generally the mole added of the Se-halide compound is 10% less than the mole of Se and/or HgSe added.

The amount of Se or HgSe used to substitute for the mercury in the HID lamps according to the invention is based on the type and the power of the lamps.

A high-intensity discharge lamp without or with low mercury, wherein Se and/or HgSe are added into the arc tube of the lamps mentioned above to substitute for the mercury completely or partially.

Se and/or HgSe with a proper mole are added into the arc tube of the lamps mentioned above to substitute for the mercury. The total atomic mole of Se and/or HgSe added into the arc tube of the lamps mentioned above is equivalent to the mole of the mercury substituted which is 5%˜100% of the original mole of the mercury packed.

When the amount of the mercury substituted by Se is 50% less than the original amount of the mercury packed, the latter can be reduced doubly. The mercury can be substituted by HgSe with 50% of the mole of the mercury substituted. Thus the atomic mole of the Se added can be kept constant.

The said high-intensity discharge lamps can be various discharge lamps packed with metallic halide or other high-intensity discharge lamps packed with mercury.

As for the lamps with xenon gas metallic halide for car, the mercury can be substituted completely by the same mole of Se or by HgSe with 50% of the mole.

As for the lamps less than 50W with metallic halide for commercial illumination, the mercury can be substituted completely by the same mole of Se or by HgSe with 50% of the mole.

As for the lamps more than 50W with metallic halide, 5% -100% of the mole of mercury packed traditionally is reduced, and substituted by the same mole of Se or by HgSe with 50% of the mole of the mercury substituted.

As for the lamps more than 100W with metallic halide for the commercial illumination, 10%˜60% of the mole of the mercury packed traditionally is reduced, and substituted by the same mole of Se or by HgSe with 50% of the reduced mole of the mercury packed.

As for the lamps more than 100W with metallic halide for stage, 20%˜60% of the mole of the mercury packed traditionally is reduced, and substituted by the same mole of Se or by HgSe with 50% of the reduced mole of the mercury packed.

The said high-intensity discharge lamps are the high pressure mercury lamps, 30%˜60% of the mole of the mercury packed traditionally is reduced, and substituted by the same mole of Se or by HgSe with 50% of the reduced mole of the mercury packed.

The said high-intensity discharge lamps are the mercury-xenon lamps, 5%˜60% of the mole of the mercury packed traditionally is reduced, and substituted by the same mole of Se or by HgSe with 50% of the reduced mole of the mercury packed.

An additional Se-halide compound can be added into the arc tube. The mole of Se-halide compound added is 10% less than the mole of the Se element added. The said Se-halide compound can be the Se-bromide and/or the Se-iodide compound.

The mercury used in the high-intensity discharge lamp without or with low mercury according to the invention can be replaced completely or the amount of it can be reduced greatly. It meets the trend of the requirement of the environment protection, and it is a potential new type of the lamps. This light source can be made to form various structures, such as one-end, two-end or the projection structure. No matter what kinds of the structures, they will be covered in the scope of the invention.

### DESCRIPTION OF THE DRAWINGS

The drawing 1 is the schematic drawing of the structure of the electric arc tube without mercury used in the example 1 according to the invention.

The drawing 2 is the schematic drawing of the structure of the lamp with xenon gas metallic halide without mercury for car used in the example 1 according to the invention.

The drawing 3 is the schematic drawing of the structure of the commercial 35W lamp with metallic halide without mercury used in the example 2 according to the invention.

The drawing 4 is the schematic drawing of the structure of the 250W or 575W lamps with metallic halide without or with low mercury for stage or the schematic drawing of the structure of other lamps of different power with metallic halide for illumination.

1. The shell of the electric arc tube
2. The inert gas
3. The pill of the metallic halide
4. Se

### DETAILED DESCRIPTION OF THE EMBODIMENTS

The invention will be described further more in conjunction of the drawings and the following embodiments.

### Embodiment 1

The mercury used in the present electric arc tube of the 35W lamps with xenon gas metallic halide for car is replaced completely and substituted by the same mole of Se. Thus it can be made into a lamp without mercury for car with a color rendering index of more than 90. According to the standard of the present patent, the related color temperature can be adjusted to 4000K, 5000K, 6000K or to other color temperature needed by selecting properly other components of the metallic halide. The structure of the electric arc tube shown in drawing 1 can be used to make into the lamp with Se-xenon gas metallic halide for car.

### Embodiment 2

The mercury used in the present commercial illumination 35 W lamp with metallic halide can be replaced completely and substituted by the same mole of Se. The component and the amount of metallic halide and the inert gas used are known in the prior art, and a commercial lamps with metallic Se-halide as shown in drawing 3 can be made.

### Embodiment 3

The mercury packed in the present 250 W lamp with metallic halide for stage illumination is reduced properly, for example 50% of the amount of the mercury packed traditionally is reduced, and substituted by the same mole of Se, or the mercury is replaced completely and substituted by HgSe with 50% of the mole of mercury packed. The component and the amount of metallic halide and the inert gas used are known in the prior art, and a 250 W lamp with metallic halide for stage as shown in drawing 4 can be made.

### Embodiment 4

The mercury packed in the present 575 W lamp with metallic halide for stage is reduced properly, the proportion reduced is 30% of the mole of the mercury packed originally and substituted by the same mole of single Se, or 60% of the mercury is reduced and substituted by HgSe with 50% of the mole of the mercury reduced. When the amount of the metallic halide packed originally is constant, a lamp with metallic halide for stage illumination with a lower color temperature and a super high color rendering index can be made.

### Embodiment 5

The mercury packed in the present 250 W lamp with metallic halide for stage is reduced properly, the proportion reduced is 60% of the mole of the mercury packed originally and substituted by the same mole of single Se, or the mercury packed originally is substituted by HgSe with 30% of the mole of mercury packed originally and by Se with 30% of that mole. When the amount of the metallic halide packed originally is constant, a lamp with metallic halide for stage illumination with a lower color temperature and a super high color rendering index can be made.

### Embodiment 6

The mercury packed in the present 575 W lamp with metallic halide for stage is reduced properly, the proportion reduced is 40% of the mole of the mercury packed originally and substituted by the same mole of single Se, or 80% of the mercury packed originally is reduced and substituted by HgSe with 40% of the mole of the mercury. When the amount of the metallic halide packed originally is constant, a lamp with metallic halide for stage with a lower color temperature and a super high color rendering index can be made.

### Embodiment 7

The mercury packed in the present 70 W commercial lamp with metallic halide is reduced properly, the proportion reduced is 50% of the mole of the original mercury packed and substituted by the same mole of single Se, or the mercury is replaced completely and substituted by HgSe with 50% of the mole of the mercury. When the amount of the metallic halide packed originally is constant, a commercial illumination lamp with metallic halide and with a lower color temperature and a super high color rendering index can be made.

### Embodiment 8

The mercury packed in the present 250W commercial lamp with metallic halide is reduced properly, the proportion reduced is 15% of the mole of the mercury packed originally and substituted by the same mole of single Se, or 30% of the mercury is reduced and substituted by HgSe with 15% of the mole of the mercury packed originally. When the amount of the metallic halide packed originally is constant, a commercial illumination lamp with metallic halide with a lower color temperature and a higher color rendering index can be made.

### Embodiment 9

The mercury packed in the present 250 W commercial lamp with metallic halide is reduced properly, for example the proportion reduced is 30% of the mole of the mercury packed originally and substituted by the same mole of single Se, or 60% of the mercury is reduced and substituted by HgSe with 30% of the mole of the mercury packed originally. When the amount of the metallic halide packed originally is constant, a commercial illumination lamp with metallic halide with a lower color temperature and a super high color rendering index can be made.

### Embodiment 10

The mercury packed in the present 125W commercial illumination lamp with metallic halide is reduced properly, for example 20% of the mole of the mercury packed traditionally is reduced and substituted by the same mole of single Se, or 40% of the mercury is reduced and substituted by HgSe with 20% of the mole of the mercury packed originally. The component and the amount of metallic halide and the inert gas are based on the prior art. A commercial lamp with metallic halide with low mercury can be made. Thus the environmental pollution can be reduced.

### Embodiment 11

20% of mercury packed in the present 70 W lamps with a high pressure of mercury is reduced and substituted by the same mole of single Se, or 40% of the mercury is reduced and substituted by HgSe with 20% of the mole of the mercury packed originally. Thus the level of the mercury pollution can be reduced, the light effect can be increased and the color rendering index gets higher.

### Embodiment 12

10% of mole of the mercury packed in the present 500 W lamps with mercury-xenon is reduced and substituted by the same mole of single Se, or by HgSe with 50% of the mole. Thus the pollution of the mercury can be reduced partially.

### Embodiment 13

40% of the mole of the mercury packed in the present 500 W lamps with mercury-xenon is reduced and substituted by the same mole of single Se. Thus the pollution of mercury can be reduced partially.

### Embodiment 14

Other conditions being equal to the examples above, Se₂I₂ with about 5% of the mole of Se packed is added additionally into the electric arc tube. Thus the recycle of halogen-tungsten can be enhanced so as to extend the life of the lamp and improve the characteristics of the lamp.

### Embodiment 15

Other conditions being equal to that of the examples 1-13, Se₂Br₂ with about 5% of the mole of Se packed is added into the electric arc tube instead of Se₂I₂. Thus the recycle of halogen-tungsten can be enhanced so as to extend the life of the lamp and improve the characteristics of the lamp.

### Embodiment 16

Other conditions being equal to that of the examples 15, a recycling mixture of Se₂I₂ and Se₂Br₂ with about 5% of the mole of Se packed is added into the electric arc tube instead of Se₂I₂, or Se₂ Br₂. Thus the recycle of halogen-tungsten can be enhanced so as to extend the life of the lamp and improve the characteristics of the lamp.

Other structures of the Se-bromide or Se-iodide can be used in the examples 14, 15, 16 mentioned above.

What is claimed is:

1. A high-intensity discharge lamp without or with low mercury, characterized in that Se and/or HgSe is added into electric arc tube of the said lamp to substitute completely or partially for the mercury packed originally in the said lamp.

2. The high-intensity discharge lamp without or with low mercury in claim 1, characterized in that the total atomic mole of Se and/or HgSe added into the electric arc tube of the said lamp is equal to the mole of said mercury substituted which is 5%˜100% of the mole of the mercury packed originally.

3. The high-intensity discharge lamp without or with low mercury in claim 2, characterized in that said high-intensity discharge lamp is the discharge lamp packed with metallic halide.

4. The high-intensity discharge lamp without or with low mercury in claim 3, characterized in that the mercury packed in the lamp with xenon gas metallic halide for car can be replaced completely and substituted by the same mole of Se or by HgSe with 50% of that mole.

5. The high-intensity discharge lamp without or with low mercury in claim 3, characterized in that the mercury packed in the commercial illumination lamp less than 50 W packed with the metallic halide is replaced completely and substituted by the same mole of Se or by HgSe with 50% of that mole.

6. The high-intensity discharge lamp without or with low mercury in claim 3, characterized in that 5%-100% of the mole of the mercury packed traditionally in the lamp more than 50 W with metallic halide is replaced and substituted by the same mole of Se or by HgSe with 50% of the mole of the mercury substituted.

7. The high-intensity discharge lamp without or with low mercury in claim 3, characterized in that 10%-60% of the mole of the mercury packed traditionally in the commercial illumination lamp more than 100 W with metallic halide is replaced and substituted by the same mole of Se or by HgSe with 50% of the reduced mole of the mercury packed.

8. The high-intensity discharge lamp without or with low mercury in claim 3, characterized in that 20%-60% of the mole of the mercury packed traditionally in the lamp more than 100 W with metallic halide for stage is replaced and substituted by the same mole of Se or by HgSe with 50% of the reduced mole of the mercury packed.

9. The high-intensity discharge lamp without or with low mercury in claim 2, characterized in that said high-intensity discharge lamp is the high pressure mercury lamp, 30%˜60% of the mole of the mercury packed traditionally is reduced and substituted by the same mole of Se or by HgSe with 50% of the reduced mole of the mercury packed.

10. The high-intensity discharge lamp without or with low mercury in claim 2, characterized in that said high-intensity discharge lamp is the mercury-xenon lamp, 5%˜60% of the mole of the mercury packed traditionally is reduced and substituted by the same mole of Se or by HgSe with 50% of the reduced mole of the mercury packed.

11. The high-intensity discharge lamp without or with low mercury in any claims 1-10, characterized in that an additional Se-halide compound is added into the electric arc tube.

12. The high-intensity discharge lamp without or with low mercury in claim 11, characterized in that the mole of Se-halide compound added is 10% less than the mole of the Se element added.

13. The high-intensity discharge lamp without or with low mercury in claim 12, characterized in that said Se-halide is Se-bromide and/or Se-iodide.
